(19) United States
(12) Patent Application Publication
(10) Pub. No.: US 2011/0176845 A1
(43) Pub. Date: Jul. 21, 2011

(54) LUBRICANT APPLICATION DEVICE AND IMAGE FORMING APPARATUS

(75) Inventors: Ikuko Kanazawa, Tokyo (JP); Kuniaki Kashiwakura, Aichi (JP); Yoshiki Nakane, Aichi (JP)

(73) Assignee: Konica Minolta Business Technologies, Inc., Tokyo (JP)

(21) Appl. No.: 13/062,128

(22) PCT Filed: Aug. 14, 2009
(86) PCT No.: PCT/JP2009/064356

§ 371 Date: Mar. 3, 2011

(30) Foreign Application Priority Data
Sep. 11, 2008 (JP) 2008-233392

(51) Int. Cl. G03G 21/00

(52) U.S. Cl. 399/346

(57) ABSTRACT

A lubricant application device 12 capable of shaving a solid lubricant evenly and lubricating an image carrying member evenly has a solid lubricant 25 formed by solidifying a lubricant for lubricating the surface of an image carrying member 8 which carries images composed of a developer, and a brush roller 24 rotating while abutting against the solid lubricant 25 and the image carrying member 8, wherein the brush roller 24 has looped bristles 23 implanted in an endless state and is rotated in a direction of the rotation following the rotation of the image carrying member 8, and has a circumferential velocity of the rotation of the brush roller 24 is faster than 56% of the circumferential velocity of the image carrying member 8 and slower than 80% of the circumferential velocity of the image carrying member 8.

### TECHNICAL FIELD

The present invention relates to a lubricant application device for an image carrying member and an image forming apparatus.

### BACKGROUND ART

In electrophotographic image forming apparatuses, it is widely performed to press a cleaning blade against the surface of an image carrying member to scrape a toner remaining on the image carrying member. A technology, in which a lubricant is applied onto the surface of the image carrying member in order to reduce the friction between the image carrying member and the cleaning blade in scraping the toner, is described, for example, in Patent Document 1.

In Patent Document 1, a brush roller in which bristles made of a resin are implanted is employed, and the brush roller is rotated at a circumferential velocity, which is slightly faster than that of the image carrying member, in a direction of the rotation following the rotation of the image carrying member, and a lubricant shaved from a solid lubricant is applied onto the surface of the image carrying member.

In such a lubricant application device, each of bristles on a brush roller shaves the surface of the solid lubricant in streak form in the rotation direction of the brush roller. Since bristles on a brush have elasticity, if a groove in a rotation direction is produced in the solid lubricant, a phenomenon occurs, in which the bristles on a brush gather in the groove and shave a portion of the groove intensively to further deepen the groove. Then an amount of the lubricant to be shaved by the brush roller becomes unstable, and this results in defective cleaning of the image carrying member or causes wearing of the image carrying member or the cleaning blade to be accelerated.
Patent Document 1: Japanese Unexamined Patent Publication No. 2007-178970

### DISCLOSURE OF THE INVENTION

### Problems to be Solved by the Invention

In view of the above problem, it is an object of the present invention to provide a lubricant application device and an image forming apparatus which can shave a solid lubricant evenly, and can lubricate the image carrying member evenly.

### Means for Solving the Problems

To solve the above problem, a lubricant application device according to the present invention includes a solid lubricant formed by solidifying a lubricant for lubricating the surface of an image carrying member which carries images composed of a developer, and a brush roller rotating while abutting against the solid lubricant and the image carrying member, wherein the brush roller has looped bristles implanted in an endless state and is rotated in a direction of the rotation following the rotation of the image carrying member, and a circumferential velocity of the rotation of the brush roller is faster than 56% of the circumferential velocity of the image carrying member and slower than 80% of the circumferential velocity of the image carrying member.

In accordance with this constitution, the looped bristles abut against a wide area of the solid lubricant and shave the surface of the solid lubricant evenly. Therefore, the brush roller can apply the lubricant evenly onto the image carrying member and a temporal change in consumed amount of the solid lubricant can be reduced, and therefore by stable lubrication, lives of the image carrying member and a cleaning blade to clean the image carrying member can be lengthened and high image quality of a developing device can be maintained.

In the lubricant application device of the present invention, a bias voltage which is the same polarity as that of the developer may be applied between the brush roller and the image carrying member.

In accordance with this constitution, it is possible to prevent the developer from adhering to the brush roller and there is no change in an amount of the lubricant to be applied due to adhering of the developer.

In the lubricant application device of the present invention, the lubricant may contain zinc stearate.

In accordance with this constitution, good lubrication can be realized in a common combination of a developer carrying member and the cleaning blade.

Moreover, the image forming apparatus of the present invention has any of the above-mentioned lubricant application devices.

In accordance with this constitution, by the good lubrication of the image carrying member, images to be formed have high quality and lives of the image carrying member and the cleaning blade are long.

### Effect of the Invention

As described above, in accordance with the present invention, by rotating the brush roller having looped bristles implanted in an endless state at a circumferential velocity which is more than 56% and less than 80% of the circumferential velocity of the image carrying member, application of the lubricant to the image carrying member is even, the solid lubricant is evenly shaved, and a temporal change in consumed amount of the solid lubricant is small, and therefore image quality is high and lives of the image carrying member and the cleaning blade are long.

### BRIEF DESCRIPTION OF THE DRAWINGS

FIG. 1 is a schematic view of an image forming apparatus of a first embodiment of the present invention.

FIG. 2 is an enlarged schematic view of a lubricant application device of FIG. 1.

FIG. 3 is a table showing results of a durability test at varying rotation speeds of the lubricant application device of FIG. 2.

FIG. 4 is a table showing results of a more detail durability test of a brush A of FIG. 2.

FIG. 5 is a table showing results of a more detail durability test of a brush B of FIG. 2.

FIG. 6 is a table showing results of a more detail durability test of a brush C of FIG. 2.

FIG. 7 is a table showing results of a durability test, in which a bias voltage is not applied, of the brush B of FIG. 2.

FIG. 8 is a table showing results of a durability test, in which a bias voltage is applied, of the brush B of FIG. 2.

FIG. 9 is a chart showing a consumed amount of the lubricant in a durability test of the brush B and a straight brush of FIG. 2.

FIG. 10 is a chart showing an amount of the photoconductor shaved in the durability test of the brush B and the straight brush of FIG. 2.

### DESCRIPTION OF EMBODIMENT

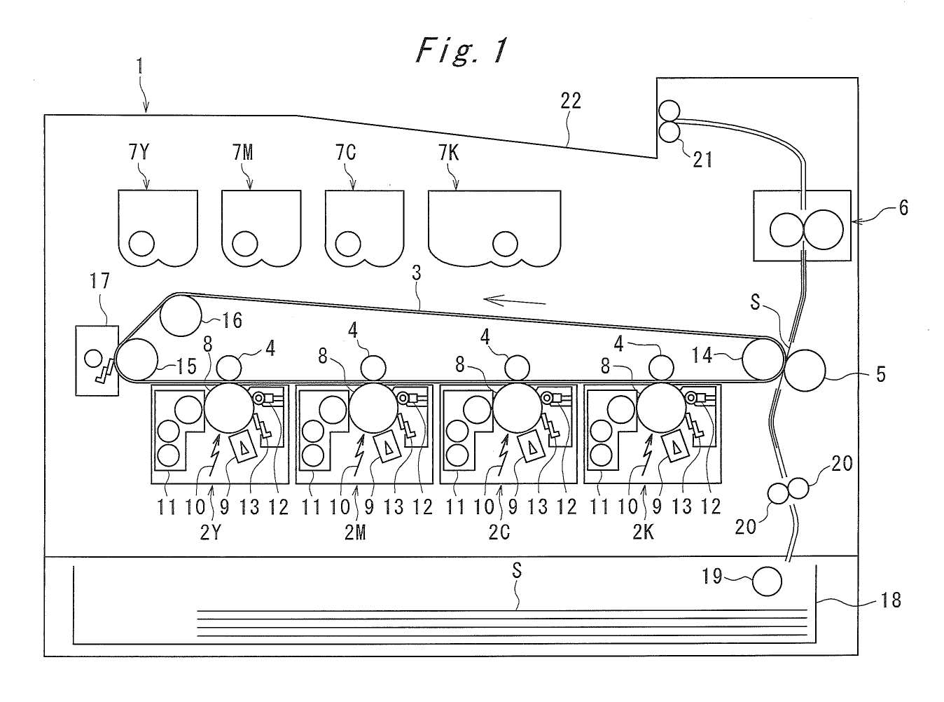

Hereinafter, embodiments of the present invention will be described referring to the drawings. FIG. 1 shows an image forming apparatus 1 of a first embodiment of the present invention. The image forming apparatus 1 has four developing units 2Y, 2M, 2C, and 2K which form an image by toners (developers) of yellow, magenta, cyan, and black, respectively, having negative charges, a transfer belt 3, a primary transfer roller 4 to transfer toner images, which the developing units 2 form, to the transfer belt 3 through an electrostatic force, a secondary transfer roller 5 to transfer toner images transferred to the transfer belt 3 to a recording paper S through an electrostatic force, a fixing device 6 which is an embodiment of the present invention and fixes the toner images by heating the recording paper S, and four toner cartridges 7Y, 7M, 7C, and 7K to supply toners of yellow, magenta, cyan, and black, respectively, to the developing units 2.

Each of the developing units 2Y, 2M, 2C, and 2K has a drum-shaped photoconductor (image carrying member) 8 to rotate, a charging unit 9 to cause the photoconductor 8 to be charged, an exposure unit 10 which selectively exposures the charged photoconductor 8 to form an electrostatic latent image, a developing unit 11 which supplies toner T to the electrostatic latent image to form toner images, a lubricant application device 12 which applies a lubricant onto the surface of the photoconductor 8, and a cleaner 13 to scrape the toner on the surface of the photoconductor 8.

The transfer belt 3 is looped over a drive roller to be rotationally driven, a driven roller 15 and a tension roller 16 to give tension, and the transfer belt 3 is moved around these rollers in a direction of an arrow by the driving roller 14. Further, the image forming apparatus 1 has a cleaner unit 17 which scrapes toner remaining on the surface of the transfer belt 3.

The recording papers S are supplied to a paper feeding section 18, and each recording paper is sent out one by one by a supply roller 19, conveyed to a secondary transfer roller 5 by a conveying roller 20, passes through a fixing device 6, and discharged to a paper-discharging section 22 by a paper-discharging roller 21.

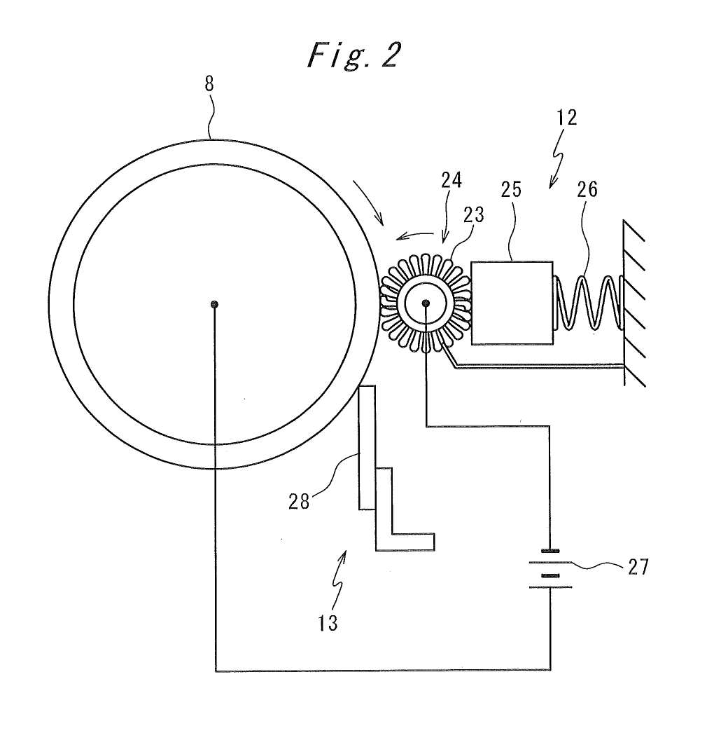

Detail of the lubricant application device 12 is shown in FIG. 2. The lubricant application device 12 has a brush roller 24 having looped bristles 23 implanted in an outer surface of a shaft in an endless state, a solid lubricant 25 formed by solidifying, for example, zinc stearate, a biasing member 26 which presses the solid lubricant 25 against the brush roller 24 with a predetermined force (for example, 2 N/m), and a bias power source 27 which applies a bias voltage of −200 V which is the same polarity as that of the toner to the brush roller 24.

The brush roller 24 is formed, for example, by winding a base cloth having a thickness of 0.5 mm, in which a bundle of conductive polyester fibers to be looped bristles 23 is woven in the shape of loop of 2.5 mm in height, around a metal shaft of 6 mm in outside diameter. Here, the conductive polyester is polyester containing carbon black.

The photoconductor 8 has a shape of a drum of 30 mm in diameter having an overcoat layer in which SiO₂ fine particles are dispersed and is configured so as to rotate at a circumferential velocity of 240 mm/sec. The lubricant application device 12 is positioned in such a manner that the photoconductor 8 dents in the brush roller 24 by about 0.5 mm.

Further, the cleaner 13 is constructed so as to press a cleaning blade 28 composed of urethane rubber of 2 mm in thickness having a hardness of 67 and impact resilience of 50, for example, against the surface of the photoconductor 8 at an abutting angle of 10° with an abutting force of 20 N/m to shave the toner remaining on the photoconductor 8.

In the lubricant application device 12, the brush roller 24 shaves the surface of the solid lubricant 25, which is pressed against the brush roller 24 by a biasing member 26, through the rotation of the brush roller 24, and applies the shaved lubricant onto the surface of the photoconductor 8. In this time, since the brush roller 24 has looped bristles 23 in an endless state, the looped bristles 23 abut against the surface of the solid lubricant over a certain length, and each looped bristle 23 scrapes the solid lubricant 25 widely. Accordingly, the brush roller 24 does not shave the solid lubricant 25 in the form of a groove in contrast to conventional brushes of straight bristle and an amount of the lubricant to be applied does not vary.

The lubricant thus applied onto the surface of the photoconductor 8 passes through a nip between the cleaning blade 28 and the photoconductor 8 with rotations of the photoconductor 8 to reduce the friction between the cleaning blade 28 and the photoconductor 8. On the other hand, the toner having a larger particle than that of the lubricant is scraped from the photoconductor 8 by the cleaning blade 28.

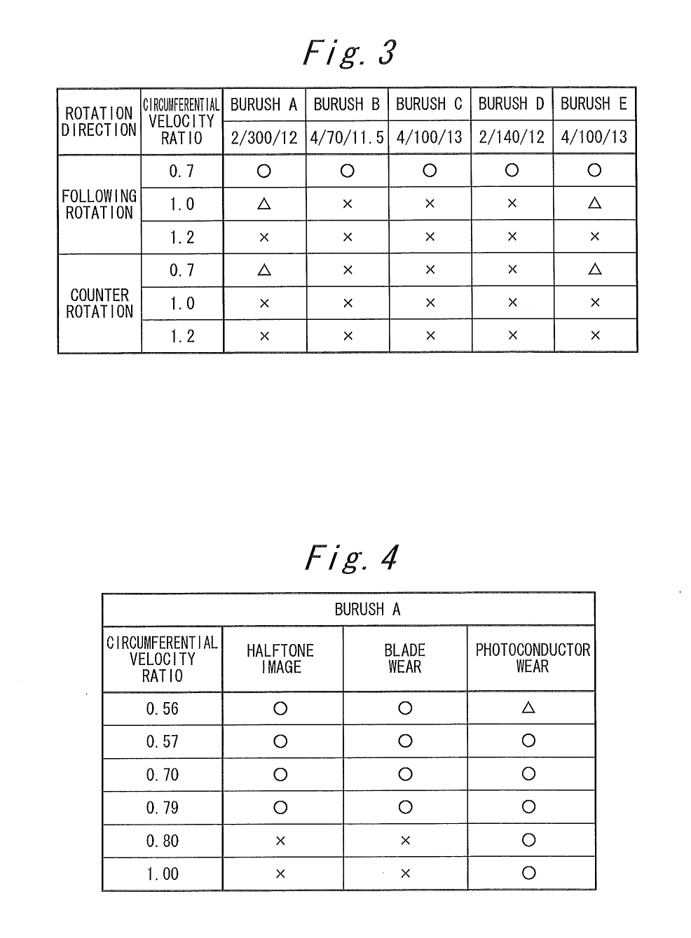

In the present embodiment, as shown in FIG. 3, five kinds of brush rollers 24 having looped bristles 23 composed of conductive polyester fibers, which have different single bristle thicknesses (decitex), fiber densities (×1,000/square inch) and single bristle resistivities (Ω/cm), and have Young's modulus of 1,200 to 1,500 N/mm², were prepared. Specifically, the brush A has looped bristles 23 having a single bristle thickness of 2 decitexes, a fiber density of 300 k/square inch, and a resistivity of 10¹² Ω/cm, the brush B has looped bristles having a single bristle thickness of 4 decitexes, a fiber density of 70 k/square inch, and a resistivity of 10^{11.5} Ω/cm, the brush C has looped bristles 23 having a single bristle thickness of 4 decitexes, a fiber density of 100 k/square inch, and a resistivity of 10¹³ n/cm, the brush D has looped bristles 23 having a single bristle thickness of 2 decitexes, a fiber density of 140 k/square inch, and a resistivity of 10¹² Ω/cm, and the brush E has looped bristles 23 having a single bristle thickness of 4 decitexes, a fiber density of 100 k/square inch, and a resistivity of 10^{11.5} Ω/cm.

FIG. 3 shows the results of a durability test which is performed by using, as the image forming apparatus 1, an apparatus configured by incorporating a brush roller into a color unit of bizhub C650 manufactured by Konica Minolta Business Technologies, Inc. so that a lubricant can be applied. The incorporated brush roller is one formed by winding a base cloth having a thickness of 0.5 mm, in which a bundle of conductive polyester fibers to be looped bristles 23 is woven in the shape of loop of 2.5 mm in height, around a metal shaft of 6 mm in outside diameter. In incorporating the brush roller 24, the photoconductor 8 was set so as to dents in the brush roller 24 by about 0.5 mm.

In a durability test shown in FIG. 3, in the environment of 10° C. and 15% RH, 300,000 sheets of character patterns corresponding to 5% of an image density were printed at a printing speed of 55 sheets/min, and then a halftone image was formed and unevenness in brush mark form or scratches on the surface of the photoconductor and in an output image were visually checked.

◯: State in which no unevenness or no scratch are produced on the surface of a photoconductor and in an output image.
Δ: State in which unevenness or scratch is recognized on the surface of a photoconductor but influences thereof are not recognized in an output image
x: State in which unevenness or scratch is produced on the photoconductor and influences thereof are also recognized in an output image.

As a result of the durability test, the image forming apparatus exhibited sufficient durability only when the brush roller 24 is rotated following the rotation of the photoconductor 8 at a circumferential velocity of 70% of the circumferential velocity of the image carrying member 8 regardless of brush rollers 24 used.

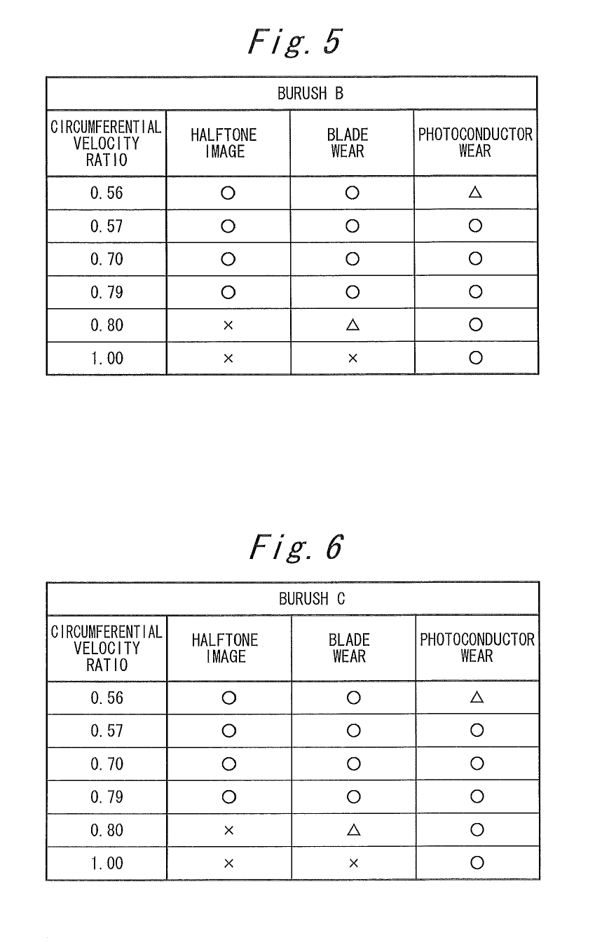

Furthermore, results of more detail durability test of three kinds of brushes 24, brushes A, B and C, are shown in FIGS. 4 to 6. Here, a rotation direction of the brush roller 24 is take as a direction of the rotation following the rotation of the photoconductor 4, and a halftone image, blade wear and photoconductor wear were evaluated.

### <Halftone Image>

The halftone image was outputted and the outputted image was visually checked to evaluate uneven application.

⊙: A level at which uneven application cannot be recognized
◯: A level of no problem
Δ: A level at which uneven application can be recognized
x: A problem level at which there are many uneven applications

### <Blade Wear>

The validity of an amount of an applied lubricant is evaluated based on an amount of blade wear. When the application of the lubricant is excessive, hiatus of an edge portion becomes significantly intense.

◯: An amount of blade wear under which a blade can be adequately used as a cleaning blade
Δ: An amount of blade wear is large a little, but a blade can be used without problems as a cleaning blade
x: A level in which blade wear is too large for using a blade as a cleaning blade and a failure such as defective cleaning occurs.

### <Photoconductor Wear>

The validity of an amount of an applied lubricant is also evaluated based on an amount of a photoconductor shaved. When the lubricant is sufficiently applied onto the photoconductor, an amount of a photoconductor film shaved can be suppressed, and therefore the amount of a photoconductor film shaved has a limit according to the photoconductor. When the amount of a photoconductor film shaved is smaller, a longer life can be achieved.

⊙: A level at which a photoconductor film is little shaved
◯: A level at which a good amount of film shaved is maintained with respect to the number of endurances
Δ: A level at which an amount of film shaved becomes much with respect to the number of endurances
x: A level at which an amount of film shaved is too much with respect to the number of endurances and a desired life cannot be achieved.

In all of these brush rollers 24, quality of a half image is deteriorated and wear of the cleaning blade occurs when a circumferential velocity of the brush roller is 80% or more of that of the photoconductor 8. Further, when the circumferential velocity of the brush roller 24 is 56% or less of that of the photoconductor 8, wear of the surface of the photoconductor 8 occurs regardless of brushes A, B and C. More specifically, when the circumferential velocity of the brush roller 24 is about 70% of that of the photoconductor 8, image quality and a state of wear are the most preferred regardless of brushes A, B and C.

From these results, it was found that in the present invention, the optimal lubrication of the photoconductor 8 can be achieved by rotating the brush roller 24 at a circumferential velocity which is more than 56% and less than 80% of the circumferential velocity of the photoconductor 8 in a direction of the rotation following the rotation of the photoconductor 8.

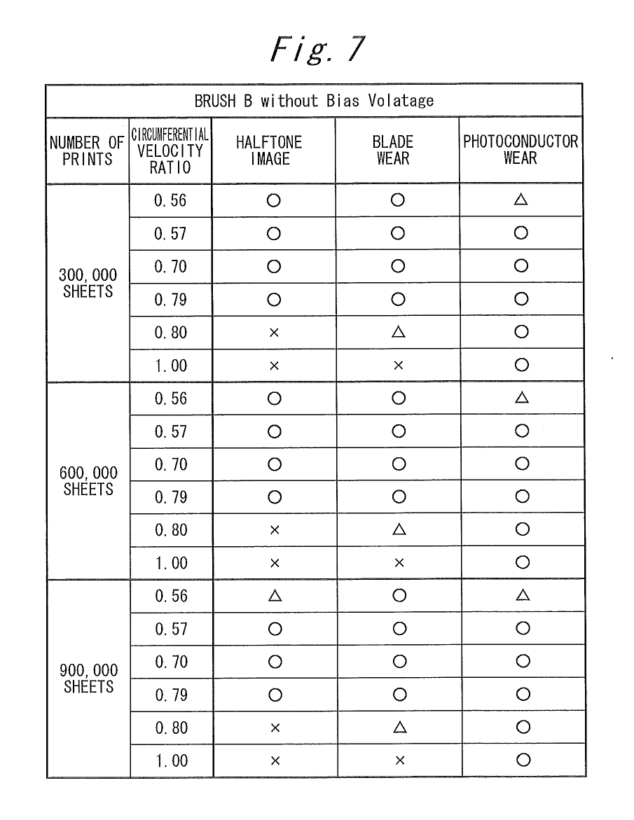

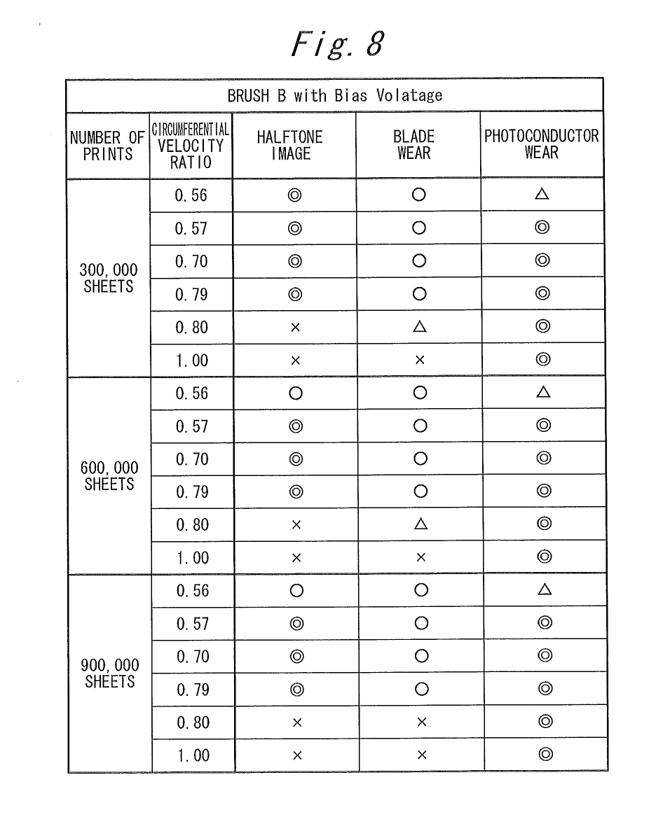

Furthermore, a durability test of the brush B, in which a bias voltage of −200 V was applied to the brush roller 24 by a bias power source 27 and further number of prints was increased, was carried out. Results of the durability test in the case where the bias voltage is not applied are shown in FIG. 7, and results of the durability test in the case where the bias voltage is applied are shown in FIG. 8. It was confirmed that by applying the bias voltage like this, a state of lubrication between the photoconductor 8 and the cleaning blade 28 is more improved and a life of the photoconductor 8 can be lengthened. The reason for this is likely that a detrimental effect of the toner on a state of a lubricant applied was suppressed since the toner does not adhere to the looped bristles 23 of the brush roller 24 by virtue of the bias voltage.

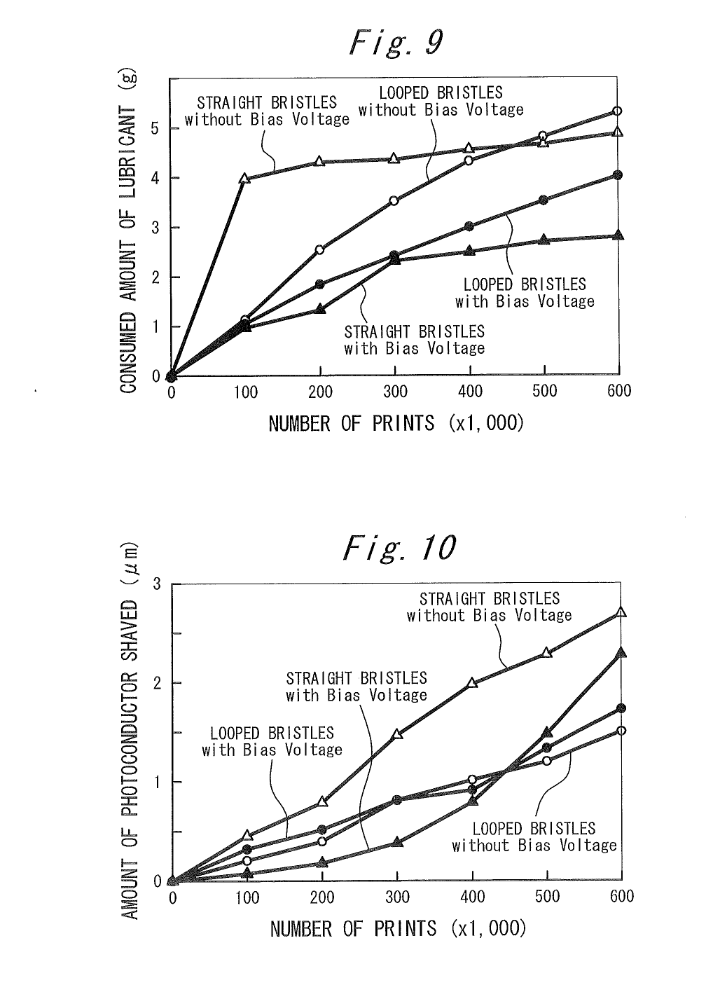

Furthermore, in addition to the brush roller 24 having the looped bristles 23 of the present embodiment, a conventional straight brush was used to perform the durability test. In FIG. 9, a difference in the consumed amount of the lubricant between the brush roller 24 of the present embodiment and the conventional straight brush is shown for each of the case where the bias voltage is applied and the case where the bias voltage is not applied. Similarly, a difference in the amount of the shaved photoconductor 8 between the brush roller 24 of the present embodiment and the conventional straight brush is shown in FIG. 10. As shown in the drawings, when the brush roller 24 of the present embodiment is used, the consumed amount of the lubricant and the amount of the shaved photoconductor 8 were constant regardless of changes in number of prints and stable lubrication could be achieved.

Moreover, in the present embodiment, as the solid lubricant 25, metal salts of various fatty acids can be used. Examples of fatty acid composing the metal salts of various fatty acid include undecylic acid, lauric acid, tridecylic acid, myristic acid, palmitic acid, pentadecylic acid, stearic acid, peptadecylic acid, arachic acid, montanic acid, oleic acid, linoleic acid, and arachidonic acid. Further, examples of the metal salt include zinc, iron, magnesium, aluminum, calcium, sodium, lithium, and barium. Particularly, metal salt of stearic acid, among these, zinc stearate is particularly preferable since an effect as a lubricant between the photoconductor and the cleaning blade having a common configuration is high and its handling in melt molding for solidifying is easy since the its melting point is low.

As a resin material used for the looped bristles 23 of the brush roller 24 in the present invention, not only polyester but also nylon, rayon, and acryl can be employed. Moreover, as the carbon black, furnace black, acetylene black, or Ketjen black may be employed. Further, metal powder may be used to impart conductivity.

### INDUSTRIAL APPLICABILITY

The lubricant application device and the image forming apparatus of the present invention can be used for monochrome and color copiers, printers, facsimiles or complex machines thereof.

### DESCRIPTION OF THE REFERENCE NUMERALS AND SYMBOLS

1 . . . image forming apparatus
2Y, 2M, 2C, 2K . . . developing unit
8 . . . photoconductor
12 . . . lubricant application device
13 . . . cleaner
23 . . . looped bristles
24 . . . brush roller
25 . . . solid lubricant
26 . . . biasing member
27 . . . bias power source
28 . . . cleaning blade

1. A lubricant application device comprising
a solid lubricant formed by solidifying a lubricant for lubricating the surface of an image carrying member which carries images composed of a developer, and
a brush roller rotating while abutting against said solid lubricant and said image carrying member, wherein
said brush roller has looped bristles implanted in an endless state and is rotated in a direction of the rotation following the rotation of said image carrying member, and a circumferential velocity of the rotation of the brush roller is faster than 56% of the circumferential velocity of said image carrying member and slower than 80% of the circumferential velocity of said image carrying member.

2. The lubricant application device according to claim 1, wherein a bias voltage which is the same polarity as that of said developer is applied between said brush roller and the image carrying member.

3. The lubricant application device according to claim 1, wherein said lubricant contains zinc stearate.

4. An image forming apparatus having the lubricant application device according to claim 1.
